(19) United States
(12) Patent Application Publication
(10) Pub. No.: US 2012/0120205 A1
(43) Pub. Date: May 17, 2012

(54) ACCELERATED BLACK FRAME INSERTION FOR DISPLAYING 3D CONTENT

(75) Inventor: Osamu KOBAYASHI, Los Altos, CA (US)

(73) Assignee: STMICROELECTRONICS, INC., Coppell, TX (US)

(21) Appl. No.: 13/295,969

(22) Filed: Nov. 14, 2011

Related U.S. Application Data
(60) Provisional application No. 61/413,789, filed on Nov. 15, 2010.

(51) Int. Cl. H04N 13/04

(52) U.S. Cl. 348/51; 348/E13.026

(57) ABSTRACT

An accelerated black frame is inserted into an output vertical blanking period, keeping the output VBI at the same length or shorter than the input VBI. The output VBI is not extended. Input video data is received at a frame memory at a first transmission rate during an input active frame period. The video data is transmitted from the frame memory to a display at a second transmission rate during an output active frame period. The second transmission rate is faster than the first rate, which would normally lead to an extended output VBI. The transmitting (pouring in of data into the frame buffer) ends at the same time as all the data has been received at the monitor (drained). A black data frame which consists of meaningless data is inserted into the output VBI such that the output VBI is not longer than the input VBI.

### CROSS-REFERENCE TO RELATED APPLICATIONS

This application claims priority under 35 U.S.C. §119(e) to Provisional Patent Application No. 61/413,789, filed Nov. 15, 2010 (Attorney Docket No. GENSP247P) entitled “Accelerated Black Frame Insertion for Displaying 3-D Content” which is incorporated by reference herein in its entirety and for all purposes.

### TECHNICAL FIELD

The present invention relates generally to display monitors. More specifically, it relates to transmitting 3D content from a frame memory to a monitor while not expanding an output vertical blanking interval.

### BACKGROUND OF THE INVENTION

It is known that when displaying 3D data, two sets of pixel values are used for each individual cell in the monitor. With frame sequential (FS) methods of displaying 3D data, data for the left eye and data for the right eye are alternately displayed in a serial manner. Active shutter glasses, which are connected to the display component, ensures that the left-eye pixel value or frame is displayed, while the right-eye shutter is shut or not displayed, followed by the right eye pixel value being displayed while the left eye shutter is shut, and this continues back and forth between the left and right eyes.

With LCD displays, which is a sample and hold type technology, each cell stores the charge and the charge is kept until the next frame. The charge stays in the cell and the brightness level is maintained. However, when LCD and FS are used together, there is content for the left eye and for the right eye shown on the monitor at the same time. That is, the left-eye content and the right-eye content are mixed. This leads to problems viewing 3D content using shutter glasses. Part of the screen (monitor) is displaying right eye frame data and another part of the screen is displaying left eye frame data. This causes problems even if one eye is covered (shut out) via one of the shutters.

### SUMMARY OF THE INVENTION

General aspects of the invention include, but are not limited to methods, systems, apparatus, and computer-readable media for enabling message transmission in multimedia device networks.

In one aspect of the invention, methods for accelerated black frame insertion into an output VBI are described. Input video data is received at a frame memory or buffer at a first transmission rate during an input active frame period. The video data is transmitted from the frame memory to a display at a second transmission rate during an output active frame period. In one embodiment the second transmission rate is faster than the first rate. Thus, video data is being drained from the frame buffer at a faster rate than the video data is being inputted (i.e., poured in). The transmitting (pouring in) ends at the same time as all the data for the frame has been received at the monitor (drained). A black data frame which consists of meaningless data is inserted into the output VBI (the interval following the output active frame period) such that the output VBI is not longer than the input VBI. The black frame may be inserted at any point during the output VBI, such as at the beginning or in the middle. At this point the process repeats thereby ensuring that none of the output VBIs is extended, that is, longer than any of the input VBIs.

It is during the output VBI that either one of the left-eye shutter glass or the right-eye shutter glass is open. This is done alternately; that is, the left-eye shutter glass is shut while the right-eye shutter glass is open and vice versa. If the display is an LCD panel, a backlight control can be used to accentuate or emphasize the video data when either one of the left-eye or right-eye shutter glasses is open.

### BRIEF DESCRIPTION OF THE DRAWINGS

The invention and the advantages thereof may best be understood by reference to the following description taken in conjunction with the accompanying drawings in which:

FIG. 1 is a series of graphs showing input and outputs of data and shutter glass states for left and right eyes in accordance with one embodiment;

FIG. 2 shows a series of graphs that correspond to the graphs in FIG. 1 however shows fewer details to more clearly show another feature of the present invention;

FIG. 3 is flow diagram of a process of inserting a black frame into an output VBI in accordance with one embodiment; and

FIGS. 4A and 4B show one physical implementation of a computing system suitable for implementing the present invention.

In the drawings, like reference numerals are sometimes used to designate like structural elements. It should also be appreciated that the depictions in the figures are diagrammatic and not to scale.

### DETAILED DESCRIPTION

Reference is made to particular embodiments of the invention. One example of which is illustrated in the accompanying drawings. While the invention will be described in conjunction with the particular embodiment, it will be understood that it is not intended to limit the invention to the described embodiment. To the contrary, it is intended to cover alternatives, modifications, and equivalents as may be included within the spirit and scope of the invention as defined by the appended claims.

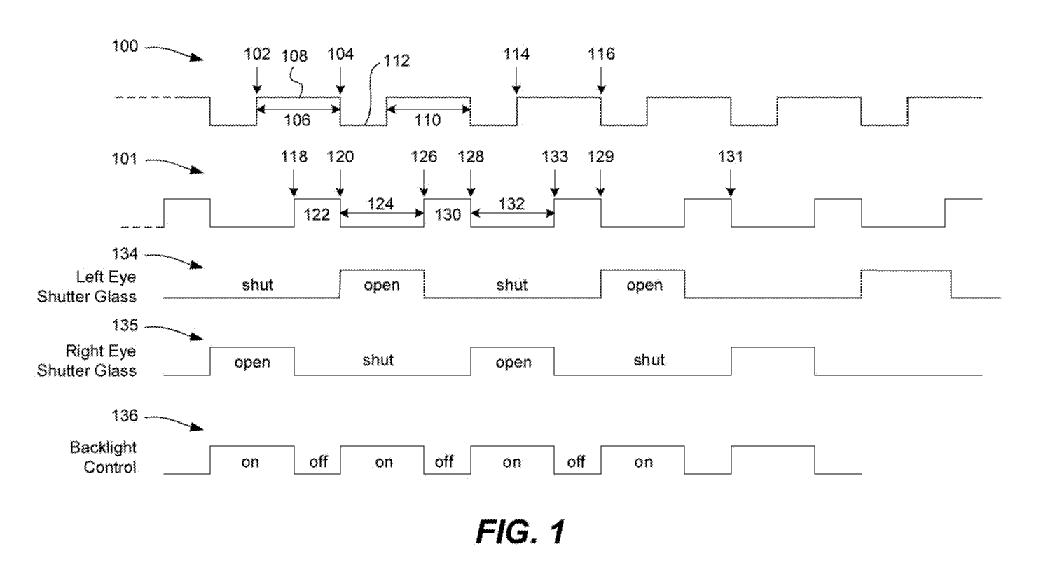

Methods and systems for display of 3D content on a monitor without expanding the output vertical blanking interval (VBI) are described in the various figures. FIG. 1 is a series of graphs showing input and outputs of data and shutter glass states for left and right eyes in accordance with one embodiment. A time graph 100 shows input of video data to a frame memory. The video data is made up of input frame data and vertical blanking intervals. An input frame N is written to a frame memory at interval 106 and the next input frame N+1 is written at interval 110 and so on. Input active line (IAL) 1 starts at point 102 which marks the beginning of an input frame period 108. If a display has 1200 active lines, then point 104 marks the end of input frame period 108 at, for example, IAL 1200 for a display having 1200 active lines. After input frame N 106 is completed, a vertical blanking interval 112 begins. Vertical blanking interval lasts until the next input frame 110 begins. No video data is sent during vertical blanking interval 112.

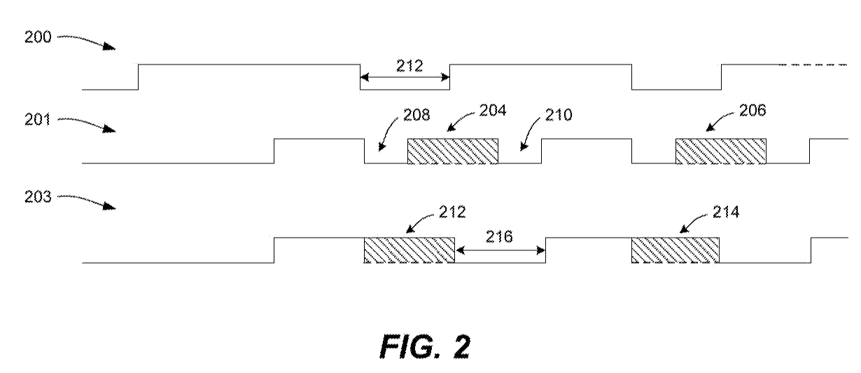

A time graph 101 shows output of data from a frame memory to a display. An output frame N is read from a frame memory to a display at interval 122, output frame N+1 as interval 130, and so on. (The input vertical period is always equal to the output vertical period.) Output active line (OAL) 1 is shown as point 118. It starts at a later time than IAL 1 at point 102. It ends at OAL 1200 at point 120 which is the same time that input frame 108 ends, that is, at IAL 1200. Thus, the output frame 122 is at a faster rate than input frame 106. Since the data output starts later (at OAL 1 at point 118), it is catching up with the input line. However, it will not pass the input line at 104 but rather end at the same time (thus, points 104 and 120 are aligned). The faster output speed and the input and output ending at the same time results in an output VBI 124 that is larger than the input VBI 112, i.e., an expanded output VBI. However, as described below in FIG. 2, in the described embodiment, even though the output data rate is faster than the input and the two end at the same time, the output vertical blanking period 124 is not expanded.

A user watching a display showing 3D video data may wear shutter glasses in order to experience the 3D effect. The left-eye shutter and the right-eye shutter may open and close at different times in order to essentially implement the 3D experience. As described below, a single eye (the left or right eye) should not be exposed to a mix of left-eye data and right-eye data at the same time. The left eye should be exposed to the screen only when the whole screen or display is showing only left eye data and, of course, the same is also true for the right eye. The display shows only entirely left eye data or entirely right eye data, which starts at OAL 1200, such as at points 120, 128, 129, 130 and so on, and ends at points 118, 126, 133, 131 and so on. Thus, only one of the left-eye shutter and the right-eye shutter should be open at once. This is shown in graphs 134 and 135. Graph 134 is for the left-eye shutter glass which is shut until output vertical blanking interval 124 begins at point 120 when the shutter glass opens. The right-eye shutter glass is open during the output vertical blanking interval before interval 124 and open again during vertical blanking interval 132, when the left-eye shutter glass is shut. The left-eye shutter glass is open again at point 129 for the next vertical blanking period. In this manner, the left and right eye shutter glasses open and close alternately during each successive output vertical blanking interval. Each one is closed during the input active frame period when the input data is loading into frame memory and left-eye data and right-eye data are mixed.

Time graph 136 shows another embodiment where the display is an LCD display and the backlight is used to accentuate the data on display when one of the shutter glasses (left eye or right eye) is open. The backlight is on when either the left-eye shutter or the right-eye shutter is open. Stated another way, the LCD backlight is one during each output vertical blanking period. It is on during this time regardless of whether it is during the input active frame period or the input vertical blanking interval.

FIG. 2 shows a series of graphs that correspond to the graphs in FIG. 1 but shows fewer details to more clearly show another feature of the present invention. Graph 200 is an input data graph having numerous vertical blanking intervals, one is shown as vertical blanking interval 212 having a certain length. For illustrative purposes, this length is four units of time. Graph 201 shows data being output from a frame memory to a display. As described above, its output data rate is faster than the input but ends at the same time, thereby creating an expanded output vertical blanking interval, such as intervals 124, 132, etc. However, in graph 201, there are two output vertical blanking intervals shown as interval 208 and interval 210. When these intervals are combined, the resulting interval is not longer than input vertical blanking interval 212, that is, it is not longer than four units. In other embodiments, the resulting output vertical blanking interval may be shorter than the input blanking period 212.

The output vertical blanking interval is not expanded because a black frame 204 (or black frame 206) is inserted during the output blanking period. Black frame 204 has no data and is not from the video source). It is essentially meaningless data that does not affect the data shown on the display (i.e., either right-eye data or left-eye data) because it is blank. By using a black frame, the user will still see the left-eye or right-eye data when the shutter glass is open. It is important to ensure that the black frame does not interfere with actual data that the eye will be exposed to when one of the shutter glasses is open. In the embodiment shown in graph 201, black frame 204 is inserted in the middle, but in other embodiments, it may be inserted at any time during the output vertical blanking interval. In this manner, the output vertical blanking interval is not being expanded, even though the output data rate is faster than the input rate. Graph 203 shows an embodiment where a black frame 212 is inserted where the output frame ends, that is, it is adjacent to the output active frame. This leaves interval 216 as the output vertical blanking period which is four units. Black frame 212 (or frame 214) can be longer making the blanking period 216 shorter than input blanking interval 212.

In the embodiment shown in graph 203, the system may continue scanning, but there is nothing left to scan from the video source and anything scanned after OAL 1200 (i.e., starting with OAL1201, which does not exist) is discarded. As noted above, one of the shutter glasses opens immediately after OAL 1200.

On the display, it is known that voltage levels shift gradually. Therefore, the upper region of a display will have had more time to get to the desired charging voltage level, that is, it will generally have more time to charge than the bottom portion of the display. By inserting a black frame, the system is giving the display more time to equalize vertical region charging differences. By inserting the black frame in the output vertical blanking interval, the system stops sending data so the difference in charging time between the upper region and the lower region is made smaller or is equalized or diminished. The black frame is giving the display time to equalize the vertical region difference.

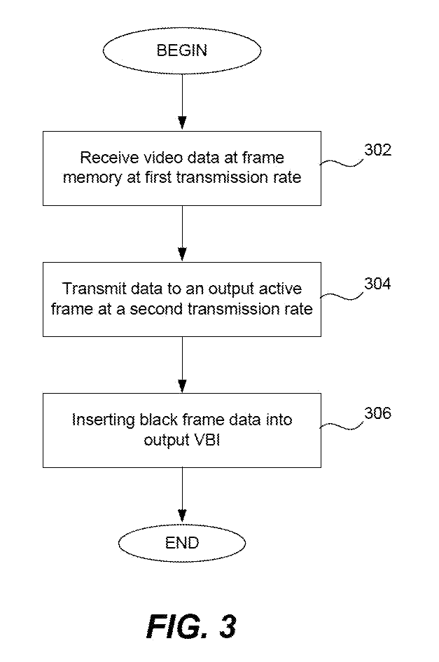

FIG. 3 is a flow diagram showing the features described above for accelerated black frame insertion into an output VBI in accordance with one embodiment. At step 302 input video data is received at a frame memory or buffer at a first transmission rate during an input active frame period. At step 304 the video data is transmitted from the frame memory to a display at a second transmission rate during an output active frame period, the second transmission rate being faster than the first rate. The transmitting ends at the same time as all the data for the frame has been received and the data is received in the output active frame after the input active frame period. At step 306 the black frame is inserted into an output VBI following the output active frame period such that the output VBI is not longer than the input VBI. The black frame may be inserted at any point during the output VBI as described above. At this point the process repeats thereby ensuring that none of the output VBIs is longer than any of the input VBIs.

Thus, to recap some of the features described above, when scanning from the top line to the bottom line, that is, when the left-eye and right-eye content is mixed, both sides of the shutter glass eyes must be closed. The user should not be allowed to see anything with either eye. Only after the entire frame is scanned (e.g., 1200 lines), should one eye shutter be open.

It is during the VBI that nothing is being shown and normally this is considered wasted time when displaying normal 2D content. When showing 2D content, the VBI should be minimized However, when displaying 3D content using frame sequential (FS) methods on an LCD display, the VBI is the only time the display can show content for one eye. This content can be seen by one eye during this time (at which time one of the shutters can close the other eye).

In one embodiment a black frame is inserted into the VBI period by the frame memory. This creates two smaller VBI intervals. The line data from the frame memory is inputted to the frame memory from a source, such as a PC graphics card. This inputting is done at a particular rate, x. The line data is read from the frame memory to a display at a faster rate, y. This is shown graphically in FIG. 1 where In_Frame_N is longer than Out_Frame_N. Thus, data is read out of frame memory faster than the data is being input to the memory. In this manner, the black frame may be described as being an accelerated black frame and the entire period may now be seen as two shorter VBI periods. The VBI period is not being extended. The display can decide how to use the black frame. The input to the frame memory does not change. Time is added because the data is being read out at a faster rate than data is being inputted. During this additional time, the black frame is sent by the frame memory. The input (e.g., from the graphics card) does not change.

As noted, a back light control signal may also be used in conjunction with the accelerated black frame insertion to enable viewing of 3D content on an LCD display. A blinking back light control enables one side (e.g., the left eye) to be off and the other side to be on, however, not at the same time. The left eye shutter and the right eye shutter are closed at the same time.

In addition, embodiments of the present invention further relate to integrated circuits and chips (including system on a chip (SOC)) and/or chip sets or packages. By way of example, each of the devices described herein may include an integrated circuit chip or SOC for use in implementing the described embodiments and similar embodiments. Embodiments may also relate to computer storage products with a computer-readable medium that has computer code thereon for performing various computer-implemented operations. The media and computer code may be those specially designed and constructed for the purposes of the present invention, or they may be of the kind well known and available to those having skill in the computer software arts. Examples of tangible computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter. Computer readable media may also be computer code transmitted by a computer data signal embodied in a carrier wave and representing a sequence of instructions that are executable by a processor. In addition to chips, chip systems, and chip sets, the invention can be embodied as firmware written to said chips and suitable for performing the processes just described.

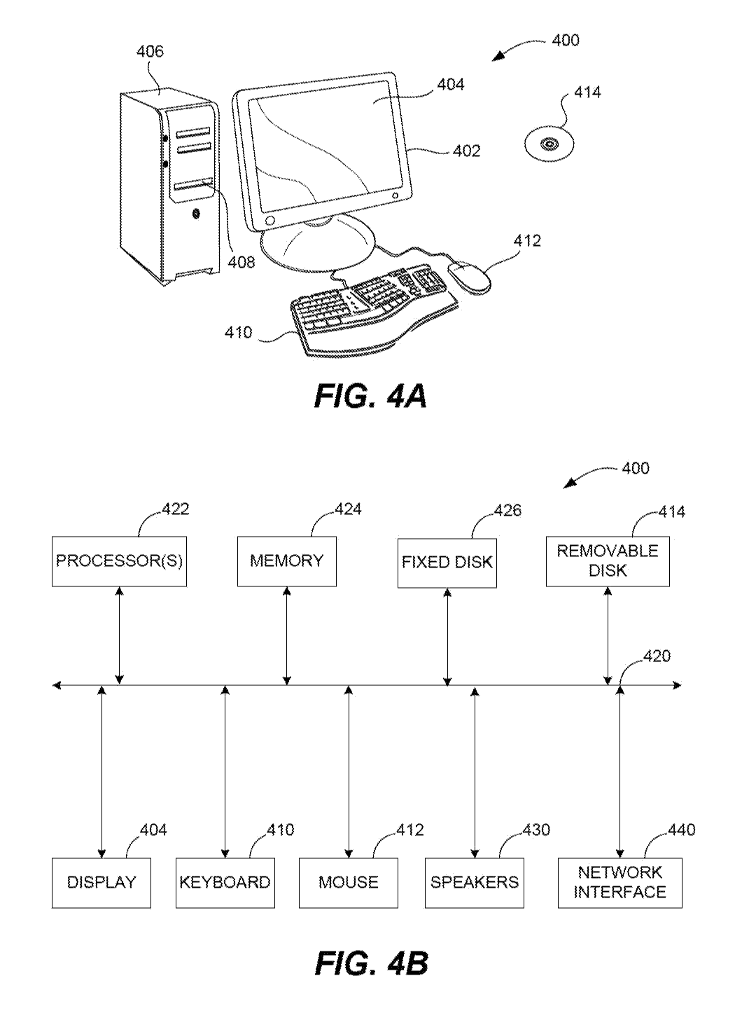

FIGS. 4A and 4B illustrate a generic computing device suitable for implementing specific embodiments of the present invention. FIG. 4A shows one possible physical implementation of a computing system. In one embodiment, system 400 includes a display 404. It may also have a keyboard 410 that is shown on display 404 or may be a physical component that is part of the device housing. It may have various ports such as HDMI or USB ports (not shown). Computer-readable media that may be coupled to device 400 may include USB memory devices and various types of memory chips, sticks, and cards.

FIG. 4B is an example of a block diagram for computing system 400. Attached to system bus 420 is a variety of subsystems. Processor(s) 422 are coupled to storage devices including memory 424. Memory 424 may include random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 426 is also coupled bi-directionally to processor 422; it provides additional data storage capacity and may also include any of the computer-readable media described below. Fixed disk 426 may be used to store programs, data and the like and is typically a secondary storage medium that is slower than primary storage. It will be appreciated that the information retained within fixed disk 426, may, in appropriate cases, be incorporated in standard fashion as virtual memory in memory 424.

Processor 422 is also coupled to a variety of input/output devices such as display 404 and network interface 440. In general, an input/output device may be any of: video displays, keyboards, microphones, touch-sensitive displays, tablets, styluses, voice or handwriting recognizers, biometrics readers, or other devices. Processor 422 optionally may be coupled to another computer or telecommunications network using network interface 440. With such a network interface, it is contemplated that the CPU might receive information from the network, or might output information to the network in the course of performing the above-described method steps. Furthermore, method embodiments of the present invention may execute solely upon processor 422 or may execute over a network such as the Internet in conjunction with a remote processor that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A method of displaying 3D content on a display, the method comprising:
receiving video data in a frame memory at a first transmission rate, said receiving occurring in an input active frame period, wherein the video data consists of input frame data and input vertical blanking interval (“VBI”);
transmitting the video data from the frame memory to a display at a second transmission rate, said transmitting occurring in an output active frame period, wherein the second rate is faster than the first transmission rate, and wherein said transmitting ends at the same time as said receiving and the output active frame begins after the input active frame period; and
inserting a black data frame into an output VBI following the output active frame period, such that the output VBI is not longer than the input VBI.

2. A method as recited in claim 1 further comprising inserting the black data frame in the middle of the output VBI.

3. A method as recited in claim 1 further comprising inserting the black data frame at the beginning of the output VBI.

4. A method as recited in claim 1 further comprising opening one of a shutter glass lens during the output VBI containing the black data frame.

5. A method as recited in claim 1 wherein the output VBI is not extended even though the output active frame begins after the input active frame period and ends at the same time as the input active frame period.

6. A method as recited in claim 4 further comprising enabling a backlight when one of a shutter glass lens is open.

7. A method as recited in claim 1 wherein the black data frame consists of meaningless data that does not affect what is being displayed.

8. An apparatus for displaying 3D content, the apparatus comprising:
means for receiving video data in a frame memory at a first transmission rate wherein said video data is received during an input active frame period, and wherein the video data consists of input frame data and input vertical blanking interval (“VBI”);
means for transmitting the video data from the frame memory to a display at a second transmission rate, wherein the video data is transmitted during output active frame period, and wherein the second rate is faster than the first transmission rate, and wherein transmission ends at the same time as the video data is received during the input active frame period and the output active frame begins after the input active frame period; and
means for inserting a black data frame into an output VBI following the output active frame period, such that the output VBI is not longer than the input VBI.

9. An apparatus as recited in claim 8 wherein the black data frame is inserted in the middle of the output VBI.

10. An apparatus as recited in claim 8 wherein the black data frame is inserted at the beginning of the output VBI.

11. An apparatus as recited in claim 8 further comprising means for opening one of a shutter glass lens during the output VBI containing the black data frame.

12. An apparatus as recited in claim 8 wherein the output VBI is not extended even though the output active frame begins after the input active frame period and ends at the same time as the input active frame period.

13. An apparatus as recited in claim 8 further comprising means for enabling a backlight when one of a shutter glass lens is open.
